(19) United States
(12) Patent Application Publication
(10) Pub. No.: US 2008/0312790 A1
(43) Pub. Date: Dec. 18, 2008

(54) Electronic Motor Vehicle Control Unit

(75) Inventors: Wolfgang Fey, Niedernhausen (DE); Michael Zydek, Frankfurt/Main (DE); Stefan Sommer, Vendersheim (DE)

Correspondence Address: CONTINENTAL TEVES, INC., ONE CONTINENTAL DRIVE, AUBURN HILLLS, MI, 48326-1581, US

(73) Assignee: Continental Teves AG & Co. OHG

(21) Appl. No.: 11/885,996

(22) PCT Filed: Mar. 8, 2006
(86) PCT No.: PCT/EP2006/060549

§ 371 Date: Aug. 6, 2008

(30) Foreign Application Priority Data
Mar. 10, 2005 (DE) 10 2005 011 540.3
Feb. 23, 2006 (DE) 10 2006 008 958.8

(51) Int. Cl. G06F 19/00

(52) U.S. Cl. 701/38

(57) ABSTRACT

Control unit for motor vehicle brakes composed of conventional function groups with an electronic brake controller and a hydraulic unit that is in particular rigidly connected to the controller, with the electronic controller comprising a redundant or partly redundant microprocessor system with several central processing units (CPU), and with the conventional function groups including a control philosophy at least for anti-lock control. Furthermore, the control unit comprises non-conventional hardware and software function groups of an otherwise external motor vehicle passenger protection safety system, which in particular does not intervene directly into driving dynamics, hence, is passive. These groups are integrated into the ambience of the control unit for motor vehicle brakes, and ambience implies that the non-conventional hardware and software function groups to be integrated are arranged at least in the immediate vicinity of the conventional electronic brake controller.

### BACKGROUND OF THE INVENTION

The present invention relates to an electronic control unit for motor vehicle brakes having an electronic brake controller and a hydraulic unit that is rigidly connected to the controller. The electronic controller has a redundant or partly redundant microprocessor system (20) with several central processing units (21), and with conventional function groups including software components with a control philosophy as well as hardware components at least for an anti-lock control (ABS) and hardware components. Non-conventional function groups of an otherwise external passive motor vehicle passenger protection safety system are provided and these are integrated into the ambience of the control unit for motor vehicle brakes, and ambience implies that the non-conventional function groups to be integrated, which can comprise in each case hardware and/or software components, are arranged at least in the immediate vicinity of the electronic brake controller.

Electronic control units for motor vehicle brake systems are jointly known and, in addition to the function anti-lock system (ABS), provide also manifold additional functions such as traction slip control (TCS) and electronic brake proportioning (EBV) at an increasing rate, but also functions for the active driving safety such as the electronic stability program (ESP).

While ABS, TCS and EBV can be regarded as safety devices of longitudinal dynamics control, ESP is used to enhance safety in the event of laterally dynamic influences on the vehicle. Especially the last mentioned system can be considered an active safety system more than the previously mentioned systems due to its driver-independent braking intervention or even steering intervention (ESP of the most recent generation).

Many types of air bag arrangements have become generally accepted likewise in the field of the passive safety systems, with the result that separate electronic control units and actuators for activation of the air bag are arranged inside a motor vehicle. These control units are often also used to control additional passive safety systems such as safety belts that can be pre-tensioned, activatable rollover bars, automatic window closing systems, etc., and frequently comprise in addition to a main processor an auxiliary processor of smaller size, which checks mathematically parts of the main function (so-called 1.5-core systems). The microprocessor systems comprised in up-to-date control units for passive safety systems generally do not meet the demands in terms of fail-safety, which must be placed on a modern ESP brake control unit.

Attempts have been made quite frequently in the field of motor vehicle electronics to integrate electronic components into joint control units in order to save costs. However, such an attempt often fails because the existing error concept and the demand in hardware of the functions to be integrated are incompatible.

Another idea of integration is realized with the active-passive integration approach (APIA) of Continental Teves GmbH & Co. oHG. In APIA, there is a centrally controlled system network made up of different, cross-linked control units that actively assist the driver in mastering danger situations. One major aspect is to expediently utilize the otherwise uselessly passing time between an accident that occurs and a driver reaction that is related thereto in order to provide at least a maximum possible protection of the occupants or the persons being otherwise involved in the accident, even if the accident cannot be avoided. To this effect, APIA founds on the data exchange between the electronic systems existing in a motor vehicle, which collect information about the activities of the driver, the performance of the vehicle and the environment of the vehicle.

In addition to the resulting integration of the control programs (software function groups), there are already approaches with regard to the integration of the corresponding hardware (hardware function groups). In this connection, DE 101 07 949 B4 (Temic, application date: 20 Feb. 2001) describes the principal possibility of the combination of an air bag control unit with the sensors of a brake control unit. Corresponding to the example described above, the electronics of the brake system and the electronics of the air bag control is separated now as before.

DE 44 36 162 C1 (Siemens, application date: 10 Oct. 1994) briefly discloses an ESP control system, wherein the air bag control and the ESP system are arranged in one joint housing at a central location in the motor vehicle. It is important also in this publication that the control units are arranged at a central location. This would imply that the control unit would have to be positioned below the driver seat, for example. Consequently, one can assume that with such a solution at least the hydraulic components of the brake system would have to be positioned in the engine compartment as before.

In up-to-date electronic circuits for brake systems or also driving dynamics control systems, which are equipped with corresponding devices for a reliable operation, the circuits for the passive safety systems or restraint systems are still accommodated in separate control units. In the field of the controlled brake technology, the control for the driving dynamics and brake system is often connected to the hydraulics of the brake system and the engine to form a unit according to the principle of the magnetic plug, where the necessary valve coils and the valve domes plugged therein are arranged in separate interconnected housing areas. The sensors for the ESP system including the necessary electronic evaluation unit, however, now as before are positioned mostly in a separate housing arranged in the area of the passenger cell in series vehicles, since an integration of these sensitive sensors in the electronic control unit of the brake system is technically difficult due to the place of installation and the existing vibrations. The necessary control units for the activation of the air bag (or the additional passive safety systems) are usually also arranged in the passenger cell. Communication between the control units in the vehicle takes place by way of appropriate digital networks (e.g. CAN bus).

The separate spatial positioning of the motor vehicle control units listed above, which enhance the active and passive driving safety, is disadvantageous among others, because sensors being used for the same physical quantity partly exist several times (for example, acceleration sensors or even yaw rate sensors). The same applies to the actuator system comprising actuator driver and actuator. Consequently, the reaction to occurring faults and the underlying philosophy in up-to-date vehicles equipped with complex safety systems is highly heterogeneous and little adapted to each other. Another shortcoming is involved in the extent of fail-safety in per se known passive safety systems on account of a protected microprocessor system, which exists only within limits in the corresponding control unit.

Among other aspects, the invention deals with overcoming the related drawbacks. Therefore, the object of the invention resides in eliminating the shortcomings of an all in all heterogeneous active-passive safety system comprising several control units that are distributed in the vehicle with at least partly differing safety concepts while, in doing so, reducing the costs incurred and the complexity in consideration of great fail-safety of the overall system.

### SUMMARY OF THE INVENTION

The invention relates to an electronic control unit having an electronic brake controller and a hydraulic unit that is rigidly connected to the controller. The electronic controller has a redundant or partly redundant microprocessor system (20) with several central processing units (21), and with conventional function groups including software components with a control philosophy as well as hardware components at least for an anti-lock control (ABS) and hardware components. Non-conventional function groups of an otherwise external passive motor vehicle passenger protection safety system are provided and these are integrated into the ambience of the control unit for motor vehicle brakes, and ambience implies that the non-conventional function groups to be integrated, which can comprise in each case hardware and/or software components, are arranged at least in the immediate vicinity of the electronic brake controller, which achieves this object.

The invention starts from the idea that brake systems for motor vehicles being equipped with, among others, the functions ABS-ESP, or even EHB (brake-by-wire) in large series are on the market, which satisfy very high demands in respect of redundancy, error detection, error processing and error tolerance. According to the claimed solution, the invention reaches a transfer of the high safety standards possible in the electronic brake field also to passive safety systems such as air bag, seat belt pre-tensioning systems, etc.

According to an example for a solution of the invention, a safety-critical motor vehicle control system, such as an ABS/ESP control unit and an air bag control unit are grouped in a joint control unit or in a very compact area, while in addition a cost reduction in the field of the electronic components responsible for the redundancy and/or safety concept is carried out in addition.

The control unit for motor vehicle brakes of the invention comprises conventional function groups in an electronic controller and a hydraulic unit, which is coupled to the controller especially in a rigid way. The electronic controller comprises a redundant or partly redundant microprocessor system (μP) with several central processing units (CPU). The conventional function groups comprise a control philosophy at least for anti-lock control (ABS), yet in particular electronic stability program (ESP). In addition to hardware elements, a function group can comprise also software components required for a function.

Hence, the control unit of the invention preferably concerns a fully integrated system, wherein the controller housing (ECU) and the hydraulic block (HCU) are rigidly interconnected, in particular according to the per se known principle of the hydraulic plug. Preferably, the valve coils for the hydraulic valves are therefore arranged in the controller housing, and the domes with the valve tappets project from the valve block. In this preferred embodiment, the control unit is designed in such a fashion that the coils are plugged by way of the valve domes due to joining ECU with HCU so that a uniform control unit block is achieved, which includes, especially additionally, a motor for a hydraulic pump arranged in the valve block.

According to the invention, the control unit for motor vehicle brakes further comprises non-conventional electronic hardware and software function groups such as components, processors, memories, sensors and actuators, as well as the control philosophy such as algorithms and/or software function groups, of an otherwise external passenger protection system for motor vehicles, which intervenes into the driving dynamics in particular indirectly, hence, is passive. The non-conventional function groups (hardware groups/software programs, software philosophies, software functions) e.g. comprise also the function groups of an air bag control unit, seat belt pre-tensioning system, automatic rollover bar, automatic window closing systems, etc.

According to the invention, the non-conventional function groups are integrated into the ambience of the brake control unit for motor vehicles, the term ‘ambience’ implying that the non-conventional function groups to be integrated are arranged at least in the direct vicinity of the electronic brake controller.

In the control unit according to the invention, the non-conventional components are integrated in particular at least into the interior of the electronic control unit or, what is particularly preferred, even into the controller housing of the brake control unit for motor vehicles.

The microprocessor system of the invention is fail-safe because it includes a complex redundancy concept and comprises two or more central units (microprocessor cores or also CPUs), which monitor each other for the purpose of error detection. For example, the system can operate according to the principle of complete redundancy, asymmetrical redundancy, or according to the principle of core redundancy. In this arrangement, two-core redundancy concepts are generally designed in such a fashion that the overall system is disconnected in the case of an error. To this end, e.g. the power supply lines are separated from the valves of the brake control unit when an error occurs. According to another example, however, more complex, more than two-core systems can be employed, which generally can tolerate errors in the area of one core with the remaining processor cores. These more complex systems are frequently designed so that they are not disabling, i.e. they are self-preserving. Admittedly, the said three-core or multi-core systems are considerably more fail-tolerant, yet accordingly they are also more expensive in manufacture due to the greater demand for chip surfaces and the scope of functions. It is preferred to design the hardware of the microprocessor system of the invention with regard to the redundancy concept in such a way that it disconnects completely in the case of an error or continues its operation in the case of an error in the sense of an emergency operation.

In per se known fully redundant microprocessor systems, the central units and the function groups necessary for the operation such as memories, I/O, etc. exist two times or several times. However, fully redundant systems of this type are too cost-intensive for the automotive industry.

According to an idea of the invention, the costs of manufacture of the integrated system can be reduced considerably when the per se known principle of core redundancy is used, for example. According to the core redundancy concept, only the core but not the required memory chip surface is doubled. The missing memory that is not doubled is only guarded by means of appropriate hardware measures using parity information. Mixed types have become known as well, which combine the core redundancy principle of two-core systems with the principle of the redundancy in three-core systems being apt for an emergency operation. Reference is made to the publications DE 43 41 082 (P 7583), WO 97/06487 (P 7959) and WO 99/35543 (P 9131) in connection with multi-core microprocessor systems without emergency operation capability and to WO 98/48326 (P 9009) and WO 98/48326 (P 9010) in connection with an emergency operation capability.

Therefore, the principle of the redundancy of the microprocessor system is so designed that it operates either according to the principle of symmetric redundancy or asymmetric redundancy, in particular according to the principle of core redundancy.

It is, however, likewise possible to combine two CPUs with different efficiency with each other. This principle has become known by the term ‘asymmetric redundancy’, as can be taken from EP 0 611 352 B1 (P 7255), and implies that the smaller test processor reproduces at least part of the control function of the main processor in a simplified manner. Admittedly, it is principally possible and, hence, alternatively preferred to employ the principle of asymmetric redundancy with regard to the microprocessor system according to the invention. However, an increase of the software complexity is related thereto, which mostly overcompensates the hardware saving effect in nowadays systems. Therefore, the above core-redundant systems equipped with identical CPUs but different memory configurations, are especially preferred according to the invention, which can communicate with each other by way of bus coupling units (bus drivers) not only on the inlet side and outlet side, but also on the command and data level.

According to a preferred embodiment, the electronic controller comprises a fail-safe microprocessor system and the most important basic elements of an ABS control unit. The electronic controller comprises a microcontroller with the following function groups:
a) redundantly designed microprocessor system,
b) one or more mixed analog/digital circuits for the activation of efficient actuators for the mechanical restraint systems such as squibs in particular, etc.
c) redundant cutoff circuits for the actuator activation (e.g. one or two main disconnecting elements such as main driver or safety switch), and
d) self-supporting energy supply unit.

The basic elements of an ABS control unit, as referred to hereinabove, are defined by the following basic assemblies in a non-concluding manner:
A) device for processing input signals of several wheel rotational speed sensors,
B) driver outlets for magnet coils or, more particularly, also coils for magnetic hydraulic valves,
C) especially one or more pressure sensor inlets, and
D) drivers to actuate alarm lamp(s).

The actuators for the mechanical restraint systems are preferably so-called squibs, meaning deployment devices for e.g. air bags or seat belt pre-tensioning systems.

The term ‘self-supporting energy supply unit’ or autarky circuit means a driver or an energy accumulator in the language of the invention, and groups of drivers or groups of energy accumulators can be concerned as well. E.g. charging pumps can be used as drivers, while capacitors, accumulators or batteries are suitable as energy accumulators, which can provide at short notice a quantity of energy that is necessary to deploy the squibs and, as the case may be, are appropriate to supply the circuit with the energy necessary for functioning, at least for a brief interval.

The microprocessor system preferably comprises the non-conventional function groups:
e) at least one air bag acceleration sensor or an air bag acceleration sensor network, and
f) at least one monitoring circuit for an acceleration sensor.

As actuators for the non-conventional hardware function groups, generally all actuators are used which have been used previously in passive and active safety systems. In the case of air bag restraint systems, these are preferably drivers for firing units, which consist of one or more pyrotechnical cells. Therefore, one or more drivers are used in the control unit of the invention, and these drivers are suitably integrated with the remaining electronics corresponding to the invention.

It is preferred that the microprocessor system comprises at least one safety actuator driver, such as in particular
g) at least one air bag firing stage, and/or
h) at least one driver for a seat belt pre-tensioning system.

When ‘integration’ is dealt with in connection with the invention, this means a stepwise integration that is preferred to be multi-stage. This means, in the first preferred integration stage, the non-conventional function group (software and/or hardware component) to be integrated is positioned in the area of the ambience of the control unit, in which the conventional function groups are grouped. This means that the function group to be integrated is in immediate vicinity to the control unit, whereby only short line distances have to be covered in a favorable fashion.

In the second, more preferable integration stage, the function group to be integrated is connected mechanically to the control unit, for example, in the type of a flanged housing or to the control unit by way of a plug in a directly detachable or especially in an undetachable fashion. This offers the advantage that the predominant part of the otherwise required bus cables is unnecessary.

In the third integration stage, which is more preferred still, the function group to be integrated is positioned in the interior of the electronic control unit or especially in the interior of the electronic controller housing of the brake control unit of the motor vehicle. As a result, the function group is protected against environmental effects, and a more compact type of construction of the overall assembly made up of valve block and the electronic controller control housing is achieved.

In the fourth, especially preferred integration stage, the function group to be integrated is placed on a joint strip conductor carrier along with the chips of the brake control unit. This is advantageous because the electronic elements can be manufactured at lower costs in a joint manufacturing process. Mounting space is also saved thereby.

In the fifth integration stage, which is more than especially preferred, the function group to be integrated is a component part of a set of chips developed jointly with the brake control components. It is hereby achieved that the existing function groups can jointly use other hardware function groups such as A/D converters in a fail-safe manner, provided the error concept renders this suitable. An expedient variant of this type is involved when the large-scale integrated circuits along with the microprocessor system are accommodated on a first chip (MCU), and the power circuits along with the necessary logic are accommodated on another second chip (PCU). The drivers and input circuits for the safety systems are also integrated in the second chip in this variant.

In the sixth, finally preferred integration stage, the non-conventional function group to be integrated is integrated along with the conventional function groups of the brake control unit mainly on one joint chip. It is not absolutely necessary then that this is done on a piece of semiconductor material, e.g. flip-chip technology, however, it can be particularly appropriate. The sixth integration stage allows manufacture in especially large quantities at a low specific consumption of wafer material.

Further simplification of the overall system is achieved when, according to another preferred embodiment of the electronic control unit, the joint microprocessor system
i) uses a joint analog/digital converter, which is configured redundantly in particular and which processes input signals for the brake control and input signals of the safety system.

The so achieved integrated motor vehicle brake system according to the invention is advantageous because the function groups available can be used several times. In total, the number of hardware and software function groups is reduced hereby.

Further, there is the advantage that the redundancy concept of a microprocessor system with several central units (e.g. according to the core redundancy principle) can be used for the non-conventional function groups as well. This achieves safe operation of the passive safety systems.

Furthermore, the integrated brake control unit of the invention is favorable because data exchange between the existing software function groups is rendered possible at increased speed due to shorter data connections. This allows better implementing complex driving condition evaluating algorithms for so-called pre-crash functions. For example, brake functions are obtained hereby, which help shortening the stopping distance.

Further preferred embodiments can be seen in the following description of the Figures.

The invention will be explained in detail hereinbelow making reference to examples.

### BRIEF DESCRIPTION OF THE DRAWINGS

In the accompanying drawings:

FIG. 1 shows a circuit arrangement with a circuit arrangement for a fail-safe brake control unit;

FIG. 2 is a schematic view of a circuit arrangement with the essential elements of a brake control unit and the essential elements for safety systems, which are integrated on one joint chip.

### DETAILED DESCRIPTION OF THE DRAWINGS

Among others, a redundant microcontroller system 20, logic elements 27, voltage supply unit 15, and power driver stages 21, 22, 23 (more specifically valve drivers with a pulse-width-modulated activation 21, other valve drivers 22 and relay drivers 23) and spatially separated test processors 24, 25 (watchdogs) as well as voltage supply ICs 15, 15′ are grouped on semiconductor material 2. This necessitates a modern semiconductor process, which allows ‘mixed-signal’ hardware structures, at least in part. Further, a semiconductor main relay is arranged on IC 15 and allows interrupting the current supply for the valve coils. Besides, an input/output unit 26 is provided, which is used to activate e.g. the warning lamp WL of the ABS brake system.

The microprocessor system 20 comprises two central units 21 and is designed corresponding to the core redundancy principle. This means, the memory of the two microcontrollers is not only duplicated, instead at least parts of the redundancy memory are removed, to the extent possible for redundancy reasons. The removed memory parts are guarded by corresponding hardware test functions in connection with redundancy memory areas. By way of serial bus 1, the microprocessor 20 is connected with other chip areas for the exchange of data or for the activation of the drivers 21, 22, 23 for the actuators.

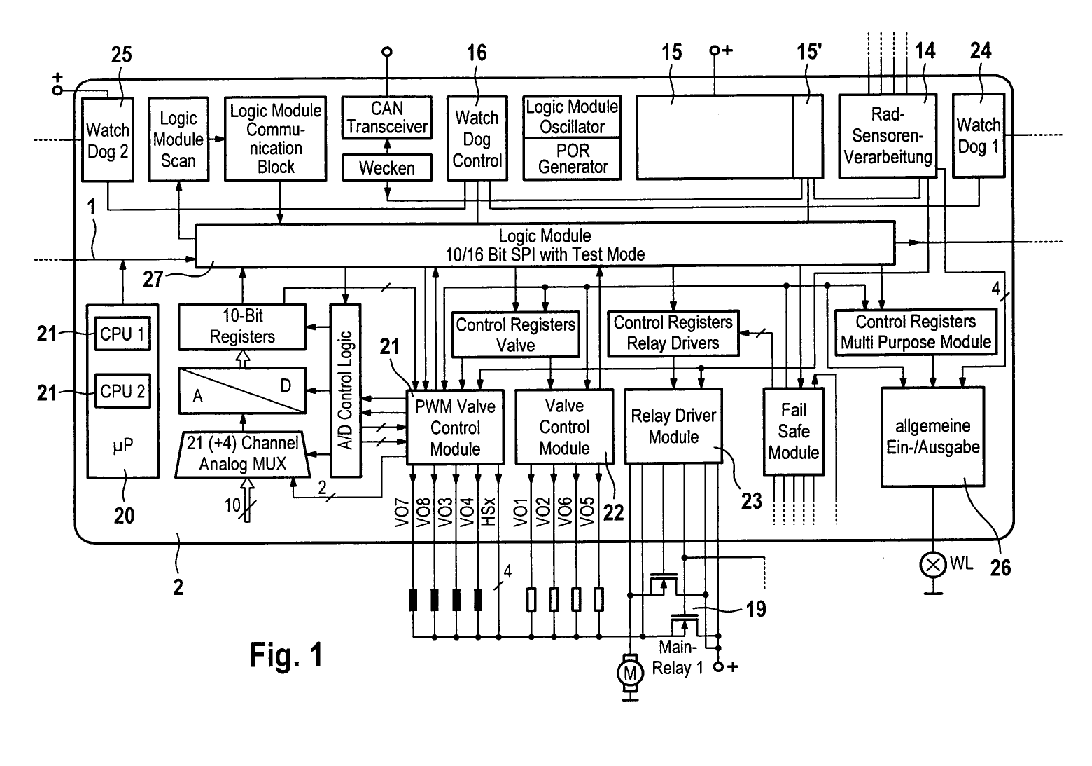

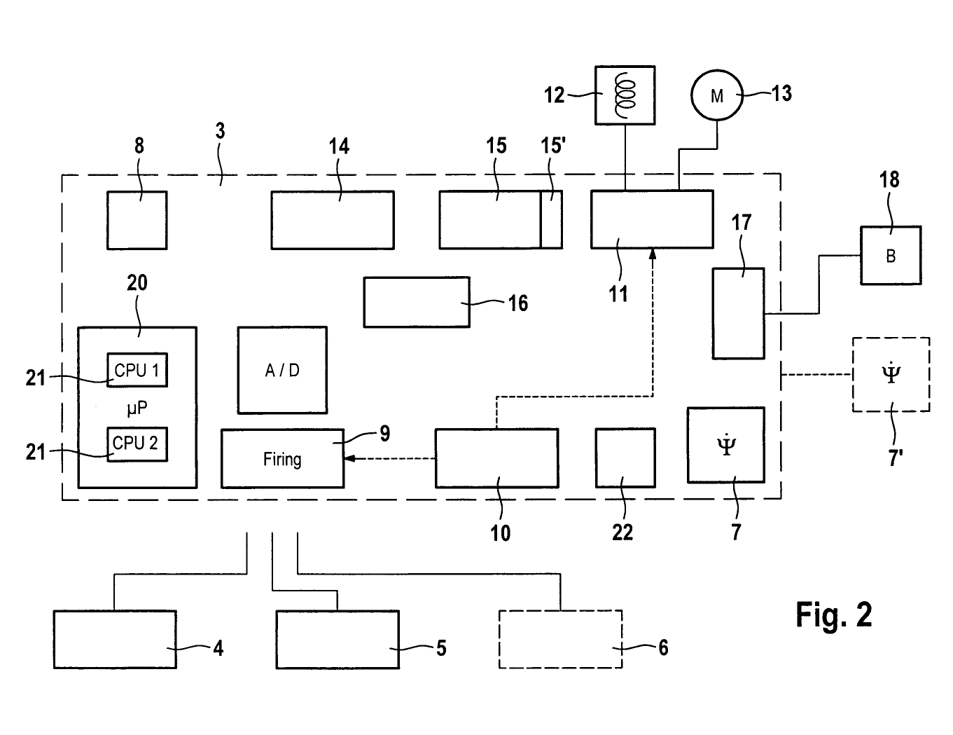

The basic elements of the circuit arrangement in FIG. 2, where the non-conventional function groups of passive safety systems are integrated on semiconductor material 3, correspond to the elements of the circuit arrangement in FIG. 1 as far as the conventional ABS/ESP function groups are concerned. Basically, the integrated non-conventional function groups concern hardware logic elements and power drivers, i.e. the software function groups of the non-conventional passive system are jointly processed in microprocessor system 20. Among others, these are driver stages 9, which are integrated on the chip for the activation of air bags 4, seat belt pre-tensioning systems 5, and possibly further actuators 6. Additional sensor inlets 22 are also provided in order to process sensor signals, which are required separately in connection with the connected passive safety systems.

Furthermore, a yaw rate sensor 7 provided for ESP can be integrated on the integral semiconductor material 3, in case the sensor is not arranged outside the chip in module 7′. Besides, autarky module 8 is positioned on chip 3 for the self-supported voltage supply of the chip or the release unit for the passive safety systems 4 to 6. Reference numeral 9 designates firing stages for the safety systems 4 to 6 (e.g. squibs). Reference numeral 10 designates a safety switch for disabling the actuator driver 9, which prevents the actuator intervention in case an error occurs in the microprocessor system 20 or any other circuit. Safety switch 10 acts on all outlets together so that there is no need for an additional, per se customary ‘safety switch’, which is provided especially for the safety systems. This switch favorably acts simultaneously on the drivers of the brake system 11, which are connected to the valve coils 12 or motor 13 for the activation of a hydraulic pump of the brake system. Reference numeral 14 designates a module for the processing of wheel rotational speed sensor signals. Reference numeral 15 refers to a joint voltage supply unit with a wake device 15′. Reference numeral 16 designates a joint watchdog, which monitors the bus, the processor and the inputs with regard to errors. Reference numerals 17 designates inlet circuits or monitoring circuits for sensors of the passive safety systems (e.g. for acceleration sensors 18).

When an error occurs in the area of the microprocessor system 20, an error signal is output through error lines (not shown) to watchdog 16, which can also be provided two times (redundantly) corresponding to FIG. 1. The watchdog will then use safety switch 10 to disconnect all outlets to the conventional and non-conventional actuators.

1-11. (canceled)

12. A control unit for motor vehicle brakes comprising:
an electronic brake controller; and
a hydraulic unit that is connected to the controller, wherein the electronic controller comprises a redundant or partly redundant microprocessor system (20) with several central processing units (21), and with conventional function groups including software components with a control philosophy as well as hardware components at least for an anti-lock control (ABS) and hardware components, and the non-conventional function groups of an external passive motor vehicle passenger protection safety system are provided and these are integrated into the ambience of the control unit for motor vehicle brakes, and ambience implies that the non-conventional function groups to be integrated are arranged at least in an immediate vicinity of the electronic brake controller.

13. The controller of claim 12, wherein the hardware of the microprocessor system disconnects completely in the case of an error or continues operating in the case of an error in the sense of an emergency operation.

14. The controller of claim 12, wherein the microprocessor system operates according to the principle of symmetrical redundancy or asymmetrical redundancy, and in the non-conventional function groups of the motor vehicle passenger protection safety system are not impaired by a disabling error.

15. The controller of claim 12, wherein the microprocessor system comprises a microcontroller, which comprises at least the following function groups: redundantly designed microprocessor system, one or more mixed analog/digital circuits for the activation of efficient actuators for the mechanical restraint systems, redundant cutoff circuits for the actuator activation, and self-supporting energy supply unit; and basic elements of an ABS control unit being defined, at least by the following assemblies: device for processing input signals of several wheel rotational speed sensors, driver outlets for magnet coils or, more particularly, also coils for magnetic hydraulic valves, especially one or more pressure sensor inlets, and drivers to actuate alarm lamps.

16. The controller of claim 12, wherein the microprocessor system comprises the non-conventional function groups: at least one air bag acceleration sensor or an air bag acceleration sensor network, and at least one monitoring circuit for an acceleration sensor.

17. The controller of claim 12, wherein the microprocessor system comprises at least one safety actuator driver.

18. The controller of claim 12, wherein the microprocessor system comprises a microcontroller, in which some or all existing non-conventional hardware function groups are integrated in a mixed analog/digital circuit.

19. The controller of claim 12, wherein an integration of the function groups takes place on the printed circuit board, more particularly in a chip or a set of chips made up of several chips.

20. The controller of claim 12, wherein the microprocessor system comprises at least one inlet for a yaw rate sensor module (e.g. ‘sensor cluster’) and/or at least one integrated yaw rate sensor.

21. The controller of claim 12, wherein the microprocessor system comprises one or more watchdog circuits monitoring the function of the microprocessor system(s).

22. The controller of claim 12, wherein the joint microprocessor system comprises one joint analog/digital converter, which has a redundant design in particular, and which processes inlet signals for the brake control as well as inlet signals for the safety system.
